(19) United States
(12) Patent Application Publication
(10) Pub. No.: US 2015/0074013 A1
(43) Pub. Date: Mar. 12, 2015

(54) SYSTEM AND METHODS FOR ROUTE EFFICIENCY MAPPING

(71) Applicant: General Electric Company, Schenectady, NY (US)

(72) Inventors: William Cherrick Schoonmaker, Melbourne, FL (US); David Allen Eldredge, Melbourne, FL (US); Jared Klineman Cooper, Melbourne, FL (US); John Welsh McElroy, Melbourne, FL (US); Timothy Robert Brown, Erie, PA (US)

(73) Assignee: General Electric Company, Schenectady, NY (US)

(21) Appl. No.: 14/161,747

(22) Filed: Jan. 23, 2014

Related U.S. Application Data
(60) Provisional application No. 61/874,452, filed on Sep. 6, 2013.

(51) Int. Cl. G06Q 10/08

(52) U.S. Cl. CPC G06Q 10/08355
USPC 705/338

(57) ABSTRACT

A system includes a simulation module and a mapping module. The simulation module is configured to simulate performance of a first mission over at least one route by a first vehicle, and to simulate the performance of the first mission using route information corresponding to one or more characteristics of the at least one route and vehicle information corresponding to one or more characteristics of the first vehicle. The simulation module is configured to determine performance characteristics for the first mission, with the performance characteristics including at least one fuel usage characteristic evaluated for plural sections of the at least one route. The mapping module is configured to provide a fuel efficiency map describing fuel usage along at least a portion of the at least one route using the performance characteristics determined by the simulation module.

### CROSS-REFERENCE TO RELATED APPLICATIONS

This application claims priority to U.S. provisional application No. 61/874,452, filed Sep. 6, 2013.

### BACKGROUND

A network for a vehicle system may include a number of routes configured to connect various destinations. For example, a rail network may include a number of routes, with each route including one or more tracks. Over time, it may become desirable or necessary to modify or change routes, and/or to modify or change the configuration of vehicles traversing the routes. The decision regarding which route or routes to employ has significant impact on expenses. For example, fuel costs, maintenance costs (for example, to replace worn track), and operating costs are all impacted by route selection and/or vehicle configuration selection.

Conventionally, however, many decisions regarding route construction and/or modification are done without a sufficiently accurate way of predicting the results of changes made to routes or configurations. For example, decisions on routes for new vehicles, elimination or addition of modifications to a route (e.g., elimination or addition of speed restrictions due to crossings), most efficient length of vehicle (e.g., number of powered and/or non-powered cars in a train), or train configuration for a given route may conventionally be made without the benefit of accurate, quantitative predictions regarding the actual costs (including operational costs) of various options.

### BRIEF DESCRIPTION

In an embodiment a system is provided that includes a simulation module and a mapping module. As used herein, the terms “system” and “module” include a hardware and/or software system that operates to perform one or more functions. For example, a module or system may include a computer processor, controller, or other logic based device that performs operations based on instructions stored on a tangible and non-transitory computer readable storage medium, such as a computer memory. Alternatively, a module or system may include a hard-wired device that performs operations based on hard-wired logic of the device. The modules shown in the attached figures may represent the hardware that operates based on software or hardwired instructions, the software that directs hardware to perform the operations, or a combination thereof.

The simulation module is configured to simulate performance of a first mission over at least one route by a first vehicle, and to simulate the performance of the first mission using route information corresponding to one or more characteristics of the at least one route and vehicle information corresponding to one or more characteristics of the first vehicle. The simulation module is configured to determine performance characteristics for the first mission, with the performance characteristics including at least one fuel usage characteristic evaluated for plural sections of the at least one route. The mapping module is configured to provide a fuel efficiency map describing fuel usage along at least a portion of the at least one route using the performance characteristics determined by the simulation module.

In an embodiment a method includes obtaining vehicle configuration information for a first vehicle. The method also includes obtaining route information for at least one route configured to be traversed by the first vehicle. Also, the method includes performing, using a simulation module (the simulation module may include at least one processor and at least one memory), a simulation of a first mission performed by the first vehicle. Further, the method includes determining, based on the simulation, performance characteristics for the first mission. The performance characteristics include at least one fuel usage characteristic evaluated for plural sections of the at least one route. The method also includes providing, using a mapping module (the mapping module may include at least one processor and at least one memory), a fuel efficiency map describing fuel usage along at least a portion of the at least one route using the performance characteristics determined by the simulation module.

In an embodiment, a tangible and non-transitory computer readable medium includes one or more computer software modules configured to direct one or more processors to obtain vehicle configuration information for a first vehicle. The software modules are also configured to direct the one or more processors to obtain route information for at least one route configured to be traversed by the first vehicle. The software modules are also configured to direct the one or more processors to perform a simulation of a first mission performed by the first vehicle. The software modules are also configured to direct the one or more processors to determine, based on the simulation, performance characteristics for the first mission, the performance characteristics comprising at least one fuel usage characteristic evaluated for plural sections of the at least one route. The software modules are also configured to direct the one or more processors to provide a fuel efficiency map describing fuel usage along at least a portion of the at least one route using the determined performance characteristics.

### BRIEF DESCRIPTION OF THE DRAWINGS

The inventive subject matter will be better understood from reading the following description of non-limiting embodiments, with reference to the attached drawings, wherein below:

FIG. 1 is a schematic view of a system including a planning module operably connected to a transportation network, according to an embodiment;

FIG. 2 illustrates an example scenario, according to an embodiment;

FIG. 3 illustrates an example scenario, according to an embodiment;

FIG. 4 is a schematic diagram of various example vehicle configurations, according to an embodiment;

FIG. 5 is a flowchart of a method for providing and/or utilizing one or more fuel efficiency maps in accordance with one embodiment.

### DETAILED DESCRIPTION

The term vehicle consist is used in this document. A vehicle consist can be a group of two or more vehicles that are mechanically coupled to travel together along a route. Optionally, a vehicle consist may have a single propulsion-generating unit or vehicle. The vehicles in a vehicle consist can be propulsion-generating units (e.g., vehicles capable of generating propulsive force, which also are referred to as propulsion-generating units, powered units, or powered vehicles) that may be in succession and connected together so as to provide motoring and/or braking capability for the vehicle consist. The propulsion-generating units may be connected together with or without other vehicles or cars between the propulsion-generating units. One example of a vehicle consist is a locomotive consist that includes locomotives as the propulsion-generating units. Other vehicles may be used instead of or in addition to locomotives to form the vehicle consist. A vehicle consist can also include non-propulsion generating units, such as where two or more propulsion-generating units are connected with each other by a non-propulsion-generating unit, such as a rail car, passenger car, or other vehicle that cannot generate propulsive force to propel the vehicle consist. A larger vehicle consist, such as a train, can have sub-consists. Specifically, there can be a lead consist (of propulsion-generating units), and one or more remote consists (of propulsion-generating units), such as midway in a line of cars and another remote consist at the end of the train.

The vehicle consist may have a lead propulsion-generating unit and a trail or remote propulsion-generating unit. The terms “lead,” “trail,” and “remote” are used to indicate which of the propulsion-generating units control operations of other propulsion-generating units, and which propulsion-generating units are controlled by other propulsion-generating units, regardless of locations within the vehicle consist. For example, a lead propulsion-generating unit can control the operations of the trail or remote propulsion-generating units, even though the lead propulsion-generating unit may or may not be disposed at a front or leading end of the vehicle consist along a direction of travel. A vehicle consist can be configured for distributed power operation, wherein throttle and braking commands are relayed from the lead propulsion-generating unit to the remote propulsion-generating units by a radio link or physical cable. Toward this end, the term vehicle consist should be not be considered a limiting factor when discussing multiple propulsion-generating units within the same vehicle consist.

A vehicle system may include one or more powered vehicles (or powered units) and one or more non-powered vehicles (or non-powered units). In certain embodiments, the vehicle system is a rail vehicle system that includes one or more locomotives and, optionally, one or more rail cars. In other embodiments, however, the vehicle system may include non-rail type vehicles, including off-highway vehicles (e.g., vehicles that are not designed or allowed by law or regulation to travel on public roads, highways, and the like), automobiles, marine vessels, and the like.

One or more embodiments of the inventive subject matter described herein provide methods and systems for improved selection or identification of vehicle routing and/or vehicle configuration. As one example, for a given route, an optimal configuration of one or more vehicles to transport goods or materials over the route may be selected from a group of potential configurations. As another example, the configuration of a new route to be constructed, or modifications to an existing route, may be optimized. Embodiments provide quantitative tools for identifying costs (e.g., fuel costs, maintenance costs, or the like) for a given route and/or vehicle configuration, allowing for improved planning and/or selection between potential routes or vehicle configurations. Various embodiments provide for accurate, convenient examination of the effect of one or more changes in route and/or vehicle configuration or operation on overall operating expenses. For example, by performing a number of simulations of differently configured routes and/or vehicles, the most efficient or effective route and vehicle configuration combinations may be identified, and/or the effects of changing various route or vehicle parameters may be studied. Additionally or alternatively, expected costs such as fuel, maintenance (e.g., for replacing worn rails) may be budgeted by simulating expected traffic over a route for a given time period. Further, areas of the route that may involve increased expense (e.g., due to rail wear) may be identified for increased maintenance activities and/or for modification.

For example, in various embodiments, an energy management engine for trip planning or other simulation tool may be used to create a software tool allowing an operations or planning department to predict costs for a given vehicle on a given route. For example, in various embodiments, the cost of fuel to perform a mission by a given rail vehicle having a given configuration (e.g., number and position of powered and non-powered vehicles) may be determined. Further, the cost of fuel or amount of fuel used may be determined for one or more portions along the length of the route (e.g., cost for the first mile (or kilometer) of the route, cost for the second mile (or kilometer), and so on). Additionally or alternatively, an amount of rail wear for portions of a route along the length of the route may be predicted. For example, areas that may see the most significant wear due to throttle and brake actions may be identified. As one example, the prediction of areas of a route that will see the most wear may be used for planning purposes, for instance to schedule maintenance and budget maintenance expenses for such areas. As another example, for a route being planned, areas for which substantial rail wear is indicated may be revised to reduce expense associated with rail wear before the route is finalized or constructed.

As indicated above, in various embodiments, a trip planner or simulator may be utilized. For example, vehicle configuration or make-up (e.g., number and position of powered vehicles such as locomotives, number and position of non-powered vehicles such as freight cars, tonnage of vehicles, or the like) may be input into the trip planner or simulator, along with route information, for example from a track database. The route information, for example, may include a track profile including information including the length of a route, grade encountered along the length of the route, curvature encountered along the route, or the like. Using the vehicle configuration and route database information, the trip planner or simulator may then perform a simulation or test run to predict vehicle performance (e.g., speed, time, fuel used) for the given vehicle and route configuration. The results of the simulated or test run may then be analyzed to determine areas of the route that may experience high wear. For example, the Davis Equation or other analytical tool may be used in conjunction with the track profile to analyze areas where vehicle speed, tractive effort (e.g., throttle, braking), and track curvature indicate areas of high rail wear. Further still, the results may be evaluated for energy used due to grade and curvature. As one example, the results may be analyzed on a “per-run” basis to predict the most efficient route for a new vehicle configuration or a change to an existing configuration. For instance, two or more different routes may connect a point of departure and a destination. The most cost-effective route for a particular configuration may be selected based on the results. As another example, results may be analyzed on a “per-mile” basis, for instance to predict areas where wear will be the highest.

At least one technical effect of various embodiments described herein includes providing a quantitative methodology for analyzing options in a transportation network, such as one or more of vehicle configuration, route selection, or route configuration (e.g., route construction, route modification), in contrast to conventional techniques that rely on experience or guesswork. Another technical effect includes improved determination of a most efficient or otherwise optimal route on which to perform a mission. Another technical effect includes improved determination of a most efficient or otherwise optimal vehicle configuration with which to perform a mission. Another technical effect includes improved estimation of costs (e.g., fuel, maintenance, or other operating costs) for budgeting and/or scheduling purposes. Another technical effect includes improved prediction of rail wear. Another technical effect includes more efficient expenditure of capital on route improvement projects.

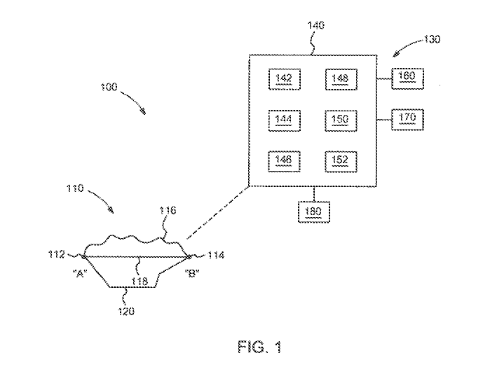

FIG. 1 is a schematic view of a system 100 including a planning module 130 operably connected to a transportation network 110. Generally, the transportation network 110 may be understood as including various routes connecting different locations. The transportation network 110 in the illustrated embodiment includes a first route 116, a second route 118, and a third route 120 extending between a starting point 112 (“A”) and an ending point 114 (“B”). It should be noted that, depending on the direction of vehicle travel, “B” may be also understood as a starting point and “A” may be understood also an ending point. Only one starting point and ending point are indicated for ease of illustration; however, multiple starting and ending points, and/or intermediate points between starting and ending points, may be utilized in various embodiments. The planning module 130 may be configured, for example, to perform scheduling, maintenance, dispatching, or the like for the transportation network 110.

In the embodiment depicted in FIG. 1, the first route 116, second route 118, and third route 120 each connect points “A” and “B,” but each route follows a different path. For example, the second route 118 may be a generally straight line between points “A” and “B,” but may have relatively large grade changes. The first route 116 may be relatively circuitous (e.g., have a relatively large number of curves or turns relative to other routes), but may be generally level. The third route 120 may be less circuitous but have more grade changes than the first route 116, and may be more circuitous but have fewer grade changes than the second route 118. Other factors that vary among the routes may be fuel availability, length of sidings or other limitations on vehicle length, quality or capacity of track, speed restrictions, or the like. Given the differences between the routes, one route may be more effective or efficient for a given vehicle configuration than the other routes, while a different route may be more effective or efficient for a different vehicle configuration. Embodiments provide for quantitatively analyzing the effect of each route/vehicle configuration combination on fuel use, maintenance (wear), or other cost/benefit analysis to improve selection of a vehicle configuration and/or a route for a given mission or group of missions.

It may be noted that an analysis or optimization may be performed in accordance with various embodiments from the perspective of planning a mission (or missions), and/or from the perspective of planning a route (e.g., planning construction of a new route or planning modifications to a current route). For example, in the illustrated embodiment, for a given vehicle configuration to perform a specified mission, a first simulated trip performing the mission may be simulated using the first route 116, a second simulated trip performing the mission may be simulated using the second route 118, and a third simulated trip performing the mission may be simulated using the third route 120 by the planning module 130. To schedule the actual mission, the route giving the best results (e.g., one or more of fuel costs, maintenance costs, total operating costs, emissions, or fuel efficiency, among others) may be selected by the planning module 130. Alternatively or additionally, vehicle configuration may be varied to select an optimal combination of route and configuration.

As another example, given a known volume of missions to be performed over a life cycle of route, simulations of the volume of missions may be performed by the planning module 130, and fuel, maintenance, and/or other operating costs may be determined by the planning module 130 based on the simulations for each potential route to be constructed (and/or each potential modification to route) to select the most effective or efficient route to be constructed (or modification to the route). Additionally or optionally, vehicle configurations to perform the volume of missions may be varied as well to evaluate combinations of vehicle configurations with route construction options or route modification options. Yet further still additionally or alternatively, operating parameters of missions (e.g., target speeds, speed limits, effect of breaking a vehicle system having a large number of cars into two or more vehicle system performing separate missions, or the like) may also be evaluated.

In the illustrated embodiment, the planning module 130 includes a processing module 140, an input module 160, and an output module 170. Generally, in various embodiments, the input module 160 is configured to receive or obtain information corresponding to a route and/or vehicle configuration to be evaluated. For example, the input module 160 may include one or more of a keyboard, mouse, touchscreen or the like. In various embodiments, an operator may input information describing or corresponding to a route, a vehicle configuration, or mission objectives. As one example, an operator may input a specified route (e.g., first route 116), a specified train configuration (e.g., describing number and location of powered vehicles, number and location of cargo vehicles, weight distribution, power capabilities, braking capabilities, weight distribution or the like), and mission objectives (e.g., maximum time for mission, maximum emission levels, speed limits along the route, or the like). In some embodiments, an operator may select from a prompt from the input module 160 listing one or more options for route or vehicle configuration. In some embodiments, the input module 160 may be configured to communicate remotely with an operator and receive input, for example, wirelessly. Generally, the display module 170 is configured to display results of simulations, results of evaluations of potential routes and/or vehicle configurations, and/or to display options to a user. For example, a user may select to perform additional simulations, to modify a previous simulation, or the like. Further, the display module 170 and the input module 160 may be configured to display options regarding settings and allow a user to adjust settings. For example, a cost of fuel or other cost parameter may be adjusted by an operator. Further, the combination of particular parameters for which to optimize and/or evaluate a configuration and/or route may be input by an operator. In various embodiments, one or more aspects of the display module 170 and the input module 160, such as a touchscreen, may be shared between the display module 170 and the input module 160.

The processing module 140 includes a route database 142, a simulation module 144, an efficiency mapping module 146, a rail wear determination module 148, an evaluation module 150, and a memory 152. Generally, in various embodiments, the route database 142 is configured to store information regarding one or more routes to be evaluated. The information may include for example, grade at various portions along the route, curvature at various portions along the route, information regarding the availability of fuel along the route, location and length of sidings along the route, quality of the route, information regarding any upcoming scheduled maintenance activities for any portions of the route, or the like. The simulation module 144 may simulate performed missions based on vehicle configuration and route selected. Optionally, the simulation module 144 may plan or optimize the performance of the simulated missions. The efficiency mapping module 146 in the illustrated embodiment is configured to receive information corresponding to simulation results, and to map the results (e.g., fuel efficiency results) for each mission along the particular route followed by that mission. The depicted rail wear determination module 148 is configured to determine the predicted or projected rail wear along the length of a route for each simulation. The evaluation module 150 is configured to select one or more routes (or modifications to routes) and/or vehicle configurations to accomplish one or more objectives based on the simulation results. Generally, in various embodiments, the processing module 140 (and/or one or more modules or aspects of the processing module 140) may include one or more processors and one or more memories configured to perform various tasks or steps.

In the illustrated embodiment, the simulation module 144 is configured to simulate performance of at least one mission over at least one route by at least one vehicle. A mission, for example, may be understood as the traversal of a particular route by a particular vehicle. It may be noted that the vehicle configuration may be altered during the course of the mission. For example, one or more units may be added or removed from a vehicle, or cargo may be removed from (or added to) the vehicle as the mission is performed. The simulation module 144 is configured to simulate the performance of the at least one mission using route information (e.g., from the route database 142) corresponding to one or more characteristics of the at least one route and vehicle information corresponding to one or more characteristics of the at least one vehicle performing the mission. In various embodiments, the simulation module 144 may be configured to perform simulations for plural missions over one or more routes, such as to simulate the expected missions over a given time period, such as six months, a year, or the like over a given route or routes.

In the illustrated embodiment, the simulation module 144 is configured to determine performance characteristics for the at least one mission. For example, the performance characteristics may include at least one fuel usage characteristic evaluated for plural sections along a length of the at least one route, such as a fuel efficiency and/or fuel consumption for each section. In some embodiments, the simulation module may not plan or optimize performance of a mission but instead only simulate performance, while in other embodiments, the simulation module may plan or optimize performance of one or more missions to be simulated. For example, one or more missions to be simulated may each be optimized for one or more of fuel efficiency, reduced emissions, time required for mission, or the like. The simulation module 144, for example, may have access to information regarding the configuration of a vehicle performing a simulated mission, such as the number, type, and position of cars or units of the vehicle as well as information regarding each car or unit, such as length; weight; propulsion, handling, and/or braking capabilities for powered units; fuel consumption properties for powered units; weight empty or loaded for non-powered units; or the like. The simulation module 144, in various embodiments, may incorporate one or more aspects of a trip planning or other control module utilized to plan trips and/or control actual vehicles performing actual missions. For example, the simulation module 144 may be configured for trip planning as set forth in U.S. patent application Ser. No. 11/608,257, filed 8 Dec. 2007, entitled “Method And Apparatus For Optimizing Railroad Train Operation For A Train Including Multiple Distributed Power Locomotives,” U.S. Published Application No. 2007/0233335, the entire content of which is incorporated herein by reference.

The efficiency mapping module 146 of the illustrated embodiment is configured to provide a fuel efficiency map for a simulated mission based on the simulation. As used herein, a fuel efficiency map may be configured as a 2 dimensional map (e.g., overlayed on a geographic map depicting the path of the route), or may be depicted or tabulated otherwise, such as in a table. The fuel efficiency map in various embodiments may describe fuel usage (e.g., fuel usage and/or efficiency) on a per unit length basis along at least a portion of the length of the at least one route.

Below is an example efficiency map for a simulation using a given vehicle configuration over a specified route. The example below uses values selected for clarity of illustration and is provided for illustrative purposes only. It may be noted that the below table is just one example, and that other units and/or other characteristics (e.g., total resistance, resistance by type such as rolling, wind, or curve, route wear, train condition such as stretched, average speed, maximum speed, emissions, throttle settings, or the like) may be utilized or included in fuel efficiency maps in various other embodiments.

| Route | Fuel | (Ton*Mile)/ | Average |
|---|---|---|---|
| Mile | Used | Gallon | Throttle |
| 1 | 3.1 | 969 | 1 |
| 2 | 6.3 | 477 | 3 |
| 3 | 4.4 | 683 | 2 |
| Total | 13.8 | 653 | 2 |

The illustrated processing module 140 also includes a rail wear determination module 148. For example, at least one route being evaluated may include a track that in turn includes one or more rails configured for passage thereon of a rail vehicle. The rail wear determination module 148 may be configured to determine at least one rail wear characteristic using at least some of the performance characteristics determined by the simulation module. For example, the rail wear characteristic may be expressed as a relative value, such as high, low, or intermediate and be used to evaluate different sections of track relative to each other. Additionally or alternatively, the rail wear characteristic may be expressed as a quantitative value, such as an estimated number of miles, missions, or time until a portion of track may need to be replaced (e.g., based on an expected traffic level and/or expected vehicle types or configurations). In various embodiments, the rail wear determination module 148 is configured to determine a portion of fuel consumption attributable to a curvature in a curved section of the track, and to determine the at least one rail wear characteristic for the curved section of the track using the portion of fuel consumption attributable to the curvature in the track. For example, the Davis equation or similar analytic technique may be employed.

The Davis equation may be understood as a quadratic formula used to approximate rail vehicle resistance. A general expression for the Davis equation may be R=A+BV+CV², where R is rail vehicle resistance, V is the velocity of the vehicle, and A, B, and C are coefficients obtained using test data. The coefficients A and B correspond to mass and mechanical resistance, while the coefficient C corresponds to air or wind resistance. The general equation may be modified in various ways. For example, the equation may, in some instances' also be stated as Rᵤ=0.6+20/w+0.01V+KV²/(w*n), where Rᵤ is the resistance in pounds/ton, w is the weight per axle in tons, n is the number of axles, V is the speed in miles per hour, and K is a drag coefficient. The value of K may vary based on the type of unit or car.

Further, various terms of the Davis equation may be determined based on particular causes, sources, or types of resistance. For example, resistance due to curvature may be stated, in some embodiments, as r_{c}=k/R_{c}, where r_{c} is the resistance due to curvature, k is a parameter (e.g., an experimentally determined parameter) that depends on vehicle type, and R is the curve radius for a given portion of track (or average curve radius). Thus, by determining total resistance as well as resistance due to curvature, the proportion of resistance due to curvature, and the proportion of fuel consumption due to curvature, may be determined in various embodiments. Further still, the proportion of fuel consumption due to curvature may be used to estimate rail wear in various embodiments. Generally, rail wear tends to increase with increased curvature and increased throttle or braking effort.

Below is an example of a table including predicted track wear in accordance with various embodiments. The example below uses values selected for clarity of illustration and is provided for illustrative purposes only. Generally, it may be noted that higher curve resistance and throttle results in higher wear. Additional values may be tabulated in various embodiments, such as fuel consumption and fuel consumption attributable to particular cause, such as curve resistance. It may further be noted that while the examples provided herein map fuel efficiency, track wear, or other characteristics for sections of track having uniform lengths, non-uniform lengths may be employed in other embodiments. For example, a rail wear for a first length of track including a curved section may be determined and tabulated, while a rail wear for a longer, second length of track that is not curved may also be determined and tabulated. Thus, rail wear or other characteristics may be analyzed for shorter sections or particular curves along a route.

| Track | Grade | Curve | Average | Braking | Predicted |
|---|---|---|---|---|---|
| Mile | Resistance | Resistance | Throttle | Effort | Track Wear |
| 1 | 0.1 | 0.03 | 4 | 0 | Medium |
| 2 | 0.2 | 0.08 | 7 | 0 | Higher |
| 3 | 0.1 | 0.03 | 4 | 0 | Medium |
| 4 | 0.05 | 0.01 | 2 | 0 | Lower |

In various embodiments, a rail wear determination may be used as part of an evaluation to estimate maintenance costs and/or to schedule maintenance activities. Additionally or alternatively, a rail wear determination may be used to compare maintenance costs associated with one or more of different vehicle configurations, different route selections, different route modifications, or different route constructions. Further still additionally or alternatively, if, based on the evaluation of a simulation, it is determined that rail wear is excessively high, than the performance of the mission may be re-planned and/or re-optimized to perform the mission with reduced rail wear.

In the illustrated embodiment, the processing module 140 also includes an evaluation module 150. The evaluation module 150 may be configured to evaluate an overall performance for a given simulation and/or to compare simulation results (e.g., efficiency maps or total efficiency) for plural vehicle and/or route configurations, for example to select one or more optimal or preferred vehicle and/or route configurations. For example, in various embodiments, the simulation module 144 may be configured to perform plural simulations of corresponding plural missions, and the efficiency mapping module 146 configured to provide plural fuel efficiency maps based on the corresponding simulations. The evaluation module 150 is configured to select, using the plural fuel efficiency maps, between at least one of a first route or a second route; or a first vehicle configuration or a second vehicle configuration. In various embodiments, a route or vehicle configuration may be selected based on a single factor, such as fuel consumed, while in other embodiments, a route or vehicle configuration may be selected based upon a combined or weighted consideration of a number of factors, such as fuel consumed, emissions generated, maximum speed, time required for mission, rail wear and/or other operating or maintenance costs, or the like.

For example, for a given vehicle configuration (or configurations expected over a given range of time), route configuration may be varied to evaluate the performance of various routes (e.g., existing routes, prospective new routes, prospective modifications to route) on operating cost. For example, an operator may enter plural alternate routes for a given mission using the input module 160, and a simulation for each route may be performed and evaluated. Thus, in some embodiments, plural prospective new routes or modifications may be compared and quantitatively evaluated by the evaluation module 150 to determine, for example, the costs and benefits of each prospective route or modification relative to other prospective routes or modifications.

As another example, for a given route, vehicle configuration may be varied. For example, an operator may enter plural alternate vehicle configurations for a given mission or route using the input module 160, and a simulation for each vehicle configuration may be performed and evaluated. For instance, the effect of breaking a large vehicle system with a large number of units into two or more smaller vehicles with fewer units each may be evaluated. As another example, the effect of using a different number of vehicles (e.g., more or less powered vehicles) or different arrangements (e.g., distributed power vs. non-distributed power) may be evaluated. Additionally or alternatively, both vehicle and route configuration may be varied to identify a preferred combination of route and vehicle configurations. In various embodiments, fuel efficiency maps may be compared on a section by section basis or on an overall basis.

Various different prospective options (or combinations thereof) may be evaluated in various embodiments. As one example, alternate routes between a given starting point and ending point for a mission may be selected. It may be noted that a different route may be selected for a trip one way from a first point to a second point and for a return trip from the second point to the first point. For instance, one route may be more efficient for a fully loaded vehicle system, while one route may more efficient for an un-loaded vehicle system. As another example, proposed modifications to an existing route may be selected. For instance, one or more prospective paths to re-route a portion of a track (for example, around an area having a high grade) may be evaluated.

In various embodiments, the different vehicle or route configurations may be evaluated based on total operating costs. For example, the cost not just of fuel, but also prospective construction costs, and maintenance costs (based on, for example, predicted rail wear) may be added and compared. In some embodiments, a series of simulations representing expected traffic conditions (e.g., types of vehicle configurations as well as total missions performed for each particular configuration) for a lifecycle of a network may be performed, and identified associated costs (construction, fuel, maintenance, or the like) totaled and compared between options. Thus, in one example scenario, a network operator or administrator may want to select between constructing a new route or modifying an existing route (e.g., increasing a capacity of track, lengthening sidings, re-routing a portion of the route, or the like). By performing simulations of the expected traffic and analyzing efficiency maps developed based on the simulations, the costs of each option may be quantified and compared. Thus, embodiments provide for quantifying various costs associated with different routes and selecting therebetween on that basis, in contrast to present techniques that are overly reliant on guesswork or merely qualitative experience.

Further still, in various embodiments, the evaluation model may be used alternatively or additionally for budgeting and/or scheduling, for example of maintenance activities. For example, with a route determined and the number and type of vehicle configurations over a given amount of time known or estimated, a number of simulations may be performed to determine the total rail wear, fuel consumed, or the like over a given time period (e.g., six months, one year, or the like). Then, based on the simulations, a total fuel consumed may be estimated, along with a related fuel cost. As another example, based on rail wear, a number of rails to be replaced, and related cost may be estimated. Further, still, based on predicted rail wear at particular locations, maintenance (inspection, replacement, and/or repair) activities for particular locations may be estimated by the evaluation module 150 and used in scheduling maintenance activities.

In some embodiments, the system 100 may include a control system 180 configured to control a vehicle configured to traverse the transportation network 110. The processing unit 140 may be communicably coupled to the control system 180. A trip plan developed by the simulation module 144 may be communicated to and used by the control system 180 to control tractive efforts of a vehicle (e.g., the first vehicle), for controlling the vehicle while the vehicle actually travels through the transportation route. Additionally or alternatively, a fuel efficiency map developed by the efficiency mapping module 146 may be communicated to and used by the control system 180 to control tractive efforts of the vehicle (e.g., the vehicle may be controlled to adhere to settings corresponding to the fuel efficiency map where practical or possible). Thus, the fuel efficiency map may be used for control of a vehicle, as well as for planning and/or budgeting purposes.

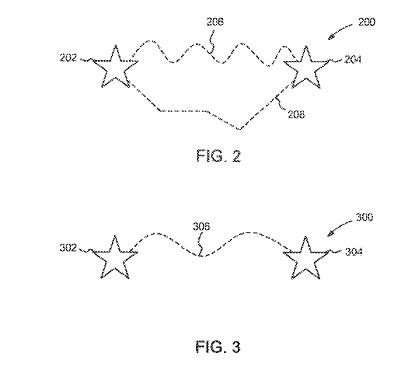

An example scenario regarding the evaluation of two different routes is present in FIG. 2. In FIG. 2, a network 200 includes points 202 and 204 joined by first route 206 and second route 208. The performance of a mission by a vehicle system (e.g., a rail vehicle consist) traversing between points 202, 204 may be evaluated for the first route 206, and the performance of the mission may also be evaluated for the second route 208. The performance may be evaluated based on one or more of fuel consumed, fuel efficiency, emissions, average speed, maximum speed, rail wear, maintenance costs, or the like. For instance, in the example scenario, the routes are compared for fuel consumption. In the example scenario, the first route 206 may have a number of curves and heavy grades as well, but may be shorter in overall length than the second route 208, which is generally straighter and has lower grades than the first route. The fuel efficiency (in Ton*Mile/Gallon) and consumption in an example scenario for traversal of routes by a vehicle system including 2 locomotives and 100 loaded coal cars weighing 12,000 tons are provided in the below table (the example below uses values selected for clarity of illustration and is provided for illustrative purposes only):

| | | Distance | (Ton*Mile)/ |
|---|---|---|---|
| Route | Fuel Used | Travelled | Gal |
| First (206) | 750 gallons | 100 miles | 1600 |
| Second (208) | 800 gallons | 110 miles | 1650 |

Thus, in the example scenario, the second route has greater efficiency on a per distance traveled basis, but the first route results in lower fuel consumption. Therefore, on a fuel usage basis, the first route 206 is the preferred route. However, it may be noted that the first route 206 has more curves and grades, and therefore may result in additional rail wear. On an overall cost basis, depending on the difference in rail wear and related maintenance, the second route 208 may provide a more overall cost effective option.

Thus, in various embodiments, the evaluation module 150 may be configured to evaluate different routes for a specific vehicle system. It may be noted that different routes may follow the same general path. For example, potential modification to the same route may be evaluated to select the most cost effective modification (or modifications) to a route. Additionally or alternatively, vehicle configurations may be varied as well. For example, a first option for a potential route may include sidings for helper vehicles, while a second option may be devoid of sidings for helper vehicles and instead employ additional powered vehicles as part of one or more vehicle configurations to traverse the route. The total costs of building and operating the network according to each option may be determined for a given number and type of missions to be performed over a life cycle of the route and compared. For example, the costs (e.g., fuel consumed, rail maintenance) of operating a given number of missions may be added to construction costs (e.g., building a siding vs. not building a siding) for each option, with the total costs for each option evaluated against each other. Other potential modifications to a route include elimination or addition of speed restrictions or crossings, or replacing a portion of route, among others.

An example scenario regarding the evaluation of two different vehicle configurations is presented in FIG. 3. In FIG. 3, a network 300 includes points 302 and 304 joined by a route 306. Performance of missions along the route by varying vehicle configurations may be simulated and compared to select a preferred vehicle configuration for a given mission. As another example, multiple vehicle configurations may be employed (for example, to simulate all missions performed along the route 306 over a given length of time), with performance characteristics averaged or totaled, for example, to evaluate a combined or total performance for the route over a given period of time. It may be noted that the configuration of a vehicle may change during the course of a mission, as for example, helper powered vehicles may be added at a siding to assist in traversing a high grade, cargo vehicles may be dropped off at one or more intermediate locations, additional cargo vehicles may be added at one or more intermediate locations, or the like.

For example, different vehicle configurations may be compared. By way of example, the number and/or capacity of powered vehicles may be varied among the evaluated configurations. As another example, one configuration may include all units in a single vehicle system, while another configuration may break the units into separate vehicle systems. For instance, one configuration may include a vehicle system having 100 cargo cars, while a second configuration may break the cargo cars up, for example, into groups of 50 cargo cars each traveling a short distance apart. Thus, various configurations of vehicle may be altered and simulated around the route. For each option a fuel efficiency map may be provided, and the evaluation module 150 may select the configuration providing the best fuel efficiency (or other desired characteristic or combination of characteristics.

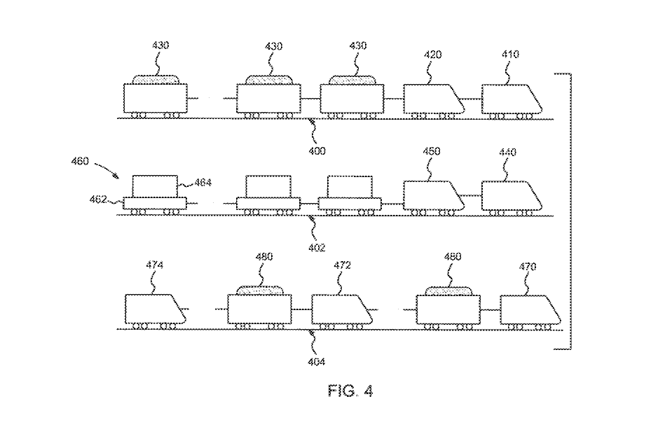

In various embodiments, a vehicle system whose performance is being simulated and evaluated may be configured as (or form a portion of) a consist including additional powered vehicles, fuel cars, and/or other non-powered vehicles. FIG. 4 illustrates a few examples of general vehicle configurations that may be evaluated. The vehicle system 400 includes first and second powered vehicles 410, 420 pulling coal cars 430. The vehicle system 402 includes first and second powered vehicles 440, 450 pulling intermodal cars 460. The intermodal car 460 includes a car 462 configured to carry a container 464. The container 464 may be configured to be transportable on one or more of a ship, rail vehicle, or truck. Thus, an intermodal vehicle system may have reduced costs of loading or off-loading cargo and transporting to or from a rail station. Because operating costs for operating an intermodal vehicle system, in various embodiments, may be quantified, the operating costs of operating a rail network with intermodal vs. non-intermodal vehicle system may be considered in the context of other costs, such as loading and off-loading costs of intermodal containers vs. boxcars, to evaluate network systems that include routes that traverse water, rails, and highways.

The vehicle system 404 is configured for distributed power. For example, the vehicle system includes a first powered vehicle 470 and a second powered vehicle 472 with a non-powered vehicle 480 (a coal car in the illustrated embodiment) interposed therebetween. Also, a non-powered vehicle 480 is interposed between the second powered vehicle 472 and a third powered vehicle 474. In various embodiments, the performance of a distributed power vehicle configuration may be compared with a non-distributed power vehicle configuration to help quantify the effects of the distributed power configuration and select an appropriate vehicle configuration for a given mission (or missions) over a given route (or routes). Further still, the particular placement of powered vehicles along the length of a distributed powered vehicle system may be varied over a number of simulations to evaluate the effect, and to select a preferred placement.

Thus, in various embodiments, different configurations of vehicles may be simulated to provide efficiency maps for each configuration, and one or more of a plurality of vehicle configuration options selected, and/or one or more routes chosen for a given vehicle configuration. For example, one route may work best with coal cars, a second route may work best with intermodal cars, and a third may work best with mixed traffic. Thus, the effectiveness or efficiency of each route of a network for different types of traffic may be evaluated and quantified, and network traffic scheduled to travel the most appropriate (e.g., efficient) available route.

Thus, in various embodiments, the planning module 130 may provide a “sandbox” or “wargaming” tool allowing different route and vehicle configuration combinations to be quantitatively examined and compared. For example, various different routes or modifications to a route may be evaluated to develop an operating budget and/or to select between routes. In various embodiments, a quantitative comparison from the perspective of costs for a route and/or network may be made, in contrast to planning or optimizing just a single trip.

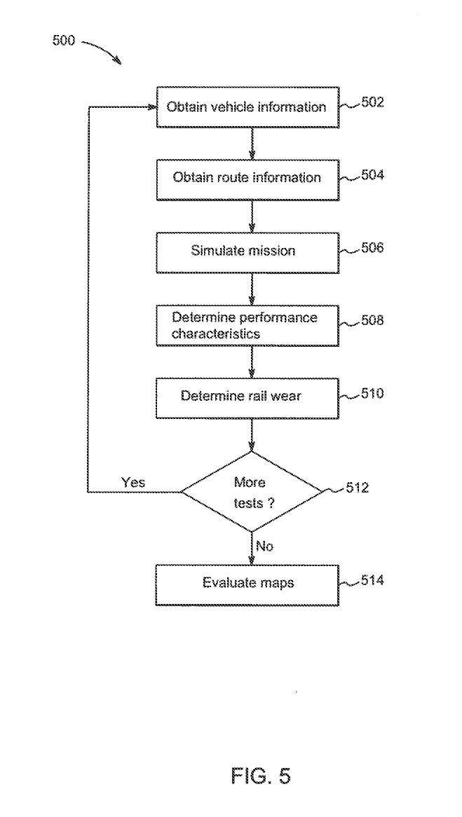

FIG. 5 illustrates a flowchart of a method 500 for providing and/or utilizing one or more fuel efficiency maps in accordance with one embodiment. The method 500 may be performed, for example, using certain components, equipment, structures, or other aspects of embodiments discussed above. In certain embodiments, certain steps may be added or omitted, certain steps may be performed simultaneously or concurrently with other steps, certain steps may be performed in different order, and certain steps may be performed more than once, for example, in an iterative fashion. In various embodiments, portions, aspects, and/or variations of the method 500 may be able to be used as one or more algorithms to direct hardware to perform operations described herein.

At 502, vehicle information is obtained. For example, vehicle configuration information corresponding to a number, type, and position of units or cars in a vehicle system may be obtained. The vehicle configuration information may include information regarding type (e.g, powered unit, intermodal car, coal car, box car), weight, handling characteristics, propulsive capability, braking capability, or the like. In some embodiments, the vehicle information may be obtained from a trip planning module that includes or has access to a database describing the vehicle configuration. As another example, in some embodiments, the vehicle configuration may be input by an operator.

At 504, route information is obtained. The route information may include information corresponding to a path taken by a vehicle (e.g., geographic coordinates along the route), grade experienced along the route, curvature experienced along the route, quality of route, identification of any portions of the route scheduled for maintenance or replacement, or the like. The route information may also include information corresponding to the placement of crossing, speed restrictions, limitations on length of vehicle due to siding lengths, or the like. The route information may be obtained, for example, from a database detailing characteristics or features of an existing route that have been mapped along the length of the route. The route information, as another example, may be input by a user. For example, a user may specify one or more characteristics of a route using an interactive display, and may modify the proposed route iteratively based on efficiency results provided by previous simulations. In some embodiments, an evaluation module (e.g., evaluation module 150) may provide suggestions on parameters or characteristics of a proposed route that may provide improved efficiency from a proposed route entered by a user. For example, the evaluation module may identify areas of high curvature that may result in excessive rail wear and suggest a route having reduced curvature in one or more areas.

At 506, a mission is simulated. A simulation module, for example, may simulate the performance of a specified mission by a vehicle (for which vehicle configuration was obtained at 502) over a route (for which route information was obtained at 504). In some embodiments, a trip planning module may be utilized to optimize the mission (e.g., set throttle and/or braking effort along the route to optimize the mission for one or more given parameters, such as fuel efficiency, time to perform mission, or the like).

At 508, one or more performance characteristics are determined from the simulation performed at 506. For example, characteristics such as speed (average, max, min), throttle (e.g., throttle notch), braking effort, fuel consumed, fuel efficiency, emissions, or the like may be determined. The characteristics may be configured for a vehicle system as a whole and/or for one or more individual units of the vehicle system (e.g., powered units such as locomotives). The characteristics may be evaluated for sections of the route, for example organized along the length of the route. As one example, characteristics for sections of uniform length (e.g., 0.1 mile, 0.5 mile, 1 mile, 0.1 kilometer, 0.5 kilometer, or 1 kilometer, among others) may be evaluated and tabulated. As another example, characteristics for differently configured sections (e.g., a curved section, a straight section, a positive grade section, a negative grade section) may be evaluated and tabulated along the length of the route. Thus, for example, a fuel efficiency map describing fuel efficiency for various sections along the length of the route may be provided based on the simulation for a given vehicle and route combination.

At 510, rail wear is determined. As one example, in various embodiments, a proportion of fuel consumed attributable to curvature in the route may be determined. In some embodiments, a variant of the Davis Equation may be employed to determine resistance due to curvature, and the proportion of fuel consumed due to curvature may be determined using the proportion of resistance due to curvature to total resistance encountered by the vehicle. The rail wear may be evaluated along different sections of the route. Generally, in some embodiments, areas where fuel consumption due to curvature is generally higher and where throttle (or braking effort) is generally higher may be identified as areas for which higher rail wear (e.g., shorter rail life) is predicted. Experimental methods (e.g., collection of data and curve fitting) may be employed to provide lifetime estimates based on particular combinations of curvature and throttle (or braking) effort.

At 512, it is determined if additional tests or simulations are required. If no more simulations are required, the method 500 proceeds to 514. If additional tests or simulations are required, the method proceeds to 502 to perform a simulation on a new route and vehicle combination. For example, if plural route alternatives are being studied, it is determined if a simulation has been performed for each proposed route (or each combination of route and vehicle configuration). It may be noted that plural simulations may be performed for a given route. For example, if various different vehicle configurations may be used with a route, a simulation may be performed for each vehicle configuration on a given route before simulations along a different route are performed. As another example, in some embodiments, fuel efficiency maps (and/or additional performance characteristics) may be used for budgeting and/or scheduling purposes. Thus, it may be determined if all types of traffic or missions expected to be performed over a given time period to be budgeted or scheduled have been performed.

At 514, one or more fuel efficiency maps are evaluated. For example, if a series of missions have been simulated for budgeting purposes, the fuel efficiency maps may be evaluated to develop a total operating cost for all expected missions or traffic over a given time period (e.g., total fuel consumed). As another example, if a series of missions have been simulated to evaluate track wear, section of track that have been identified with excessive track wear may be targeted for more frequent maintenance than sections with lower projected track wear. As another example, if a number of vehicle configurations are being evaluated for a given mission, the most efficient or otherwise effective vehicle configuration may be selected. A preferred route, vehicle configuration, or combination thereof may be identified based upon one or more of minimized fuel usage, minimized rail wear, minimized total operating cost, minimized emissions, or the like. As one more example, different projects may be compared. For example, a new route may be planned for construction for connecting two points. Three options may be available, for example a first path option that is generally straight but has a high grade, a second path option that has less grade variation but relatively high curvature, and a third path option that has less grade and less curvature but a longer total distance. Expected traffic over the alternate paths may be simulated for each path option to estimate costs over a life cycle or other time frame, and the most cost effective path selected. Operating costs (e.g., fuel costs, rail maintenance costs) may be added to projected construction costs for each route to quantitatively identify the most cost effective route. As additional examples, proposed modifications to an existing route may be examined to select one or more modification projects that provide the most benefit for the least cost. As still another example, operating strategies for operating a transportation network may be examined. For instance, in one example scenario, the relative cost of utilizing helper powered units at high grade sections may be compared to the relative cost of including more powered vehicles along the total length of a mission arranged in a distributed power arrangement. The operating costs (e.g., fuel, rail wear) may be quantified and combined with construction costs (e.g., for additional sidings for helper vehicles) to identify the most cost effective option. Thus, in various embodiments, fuel consumption and/or other operating costs may be quantified and combined with construction costs to provide a more complete analysis of available options.

Embodiments may also include computer readable media with instructions that are configured to direct a processor to execute or perform the various method operations described herein. Embodiments may also include powered vehicles including the various modules and/or components or vehicle networks described herein. Moreover, embodiments described herein may include vehicle consists that include the various modules and/or components, the vehicle networks, or the system networks described herein.

In one embodiment, a system is provided that includes a simulation module and a mapping module. The simulation module is configured to simulate performance of a first mission over at least one route by a first vehicle, and to simulate the performance of the first mission using route information corresponding to one or more characteristics of the at least one route and vehicle information corresponding to one or more characteristics of the first vehicle. The simulation module is configured to determine performance characteristics for the first mission, with the performance characteristics including at least one fuel usage characteristic evaluated for plural sections of the at least one route. The mapping module is configured to provide a fuel efficiency map describing fuel usage along at least a portion of the at least one route using the performance characteristics determined by the simulation module.

In another aspect, the at least one route may include a track including one or more rails configured for passage thereon by a rail vehicle. The system may further include a rail wear determination module configured to determine at least one rail wear characteristic using at least some of the performance characteristics determined by the simulation module. In some embodiments, the rail wear determination module is configured to determine a portion of fuel consumed for a curved section of the track attributable to a curvature in the curved section of the track, and to determine the at least one rail wear characteristic for the curved section of the track using the portion of fuel consumed attributable to the curvature in the track.

In another aspect, the simulation module is configured to perform at least a second simulation of at least a second mission, and the mapping module is configured to provide at least a second fuel efficiency map based on the at least a second simulation. The system may include an evaluation module configured to select, using the first and at least a second fuel efficiency maps, between at least one of: a first route or a second route; or to select between a first vehicle configuration or a second vehicle configuration.

In another aspect, the system may include a control module configured to control at least one of the first vehicle or one or more other vehicles, while the at least of the first vehicle or the one or more other vehicles actually travels over the at least one route. The control may be based at least in part on the fuel efficiency map.

In an embodiment, a method includes obtaining vehicle configuration information for a first vehicle. The method also includes obtaining route information for at least one route configured to be traversed by the first vehicle. Also, the method includes performing, using a simulation module (the simulation module may include at least one processor and at least one memory), a first simulation of a first mission performed by the first vehicle. Further, the method includes determining, based on the first simulation, performance characteristics for the first mission. The performance characteristics include at least one fuel usage characteristic evaluated for plural sections of the at least one route. The method also includes providing, using a mapping module (the mapping module may include at least one processor and at least one memory), a fuel efficiency map describing fuel usage along at least a portion of the at least one route using the performance characteristics determined by the simulation module.

In another aspect, the method includes method further includes performing at least one second simulation of at least a second mission. The first and the at least one second simulation differ from each other by at least one of varying vehicle configurations or varying routes. The method also may include determining performance characteristics for each of the first and at least one second simulations, and providing corresponding plural fuel efficiency maps for the first and at least one second simulations using the performance characteristics. Further, the method may include evaluating the fuel efficiency maps, where the evaluating includes comparing at least portions of the fuel efficiency maps for the simulations. Further still, in some embodiments, the evaluating includes selecting between alternate vehicle configurations based on the fuel efficiency maps.

In another aspect, the evaluating includes selecting between alternate routes based on the fuel efficiency maps. For example, the selecting between the alternate routes may include selecting between prospective routes following different paths between a starting location and an ending location. As another example, the selecting between the alternate routes may include selecting between prospective modifications to an existing route.

In another aspect, the at least one route comprises a track including one or more rails configured for passage thereon by a rail vehicle. The method may further include determining at least one rail wear characteristic using at least some of the performance characteristics. In some embodiments, the determining the at least one rail wear characteristic may include determining a portion of fuel consumed for a curved section of the track attributable to a curvature in the curved section of the track, and using the portion of fuel consumed attributable to the curvature in the track to determine the at least one rail wear characteristic for the curved section of the track.

In another aspect, the method may include controlling at least one of the first vehicle or one or more other vehicles, while said at least one of the first vehicle or the one or more other vehicles actually travel over the at least one route. The control may be based at least in part on the fuel efficiency map.

In an embodiment, a tangible and non-transitory computer readable medium includes one or more computer software modules configured to direct one or more processors to obtain vehicle configuration information for a first vehicle. The software modules are also configured to direct the one or more processors to obtain route information for at least one route configured to be traversed by the first vehicle. The software modules are also configured to direct the one or more processors to perform a first simulation of a first mission performed by the first vehicle. The software modules are also configured to direct the one or more processors to determine, based on the first simulation, performance characteristics for the first mission, the performance characteristics comprising at least one fuel usage characteristic evaluated for plural sections of the at least one route. The software modules are also configured to direct the one or more processors to provide a fuel efficiency map describing fuel usage along at least a portion of the at least one route using the determined performance characteristics.

In another aspect, the software modules are also configured to direct the one or more processors to perform at least one second simulation of at least a second mission, with the first and at least one second simulations differing from each other by at least one of varying vehicle configurations or varying routes. The software modules are also configured to direct the one or more processors to determine performance characteristics for each of the simulations. The software modules are also configured to direct the one or more processors to provide corresponding plural fuel efficiency maps for the plural simulations using the performance characteristics. The software modules are also configured to direct the one or more processors to evaluate the fuel efficiency maps by comparing at least portions of the fuel efficiency maps for the simulations.

In another aspect, the computer readable medium is further configured to direct the one or more processors to select between alternate vehicle configurations based on the fuel efficiency maps.

In another aspect, the computer readable medium is further configured to direct the one or more processors to select between alternate routes of the at least one route based on the fuel efficiency maps. Further, the computer readable medium may be configured to direct the one or more processors to select between prospective routes following different paths between a starting location and an ending location. In another aspect, the computer readable medium may be configured to direct the one or more processors to select between prospective modifications to an existing route.

In another aspect, the at least one route includes a track that includes one or more rails configured for passage thereon by a rail vehicle, and the computer readable medium is further configured to direct the one or more processors to determine at least one rail wear characteristic using at least some of the performance characteristics. The computer readable medium may be further configured to direct the one or more processors to determine a portion of fuel consumed for a curved section of the track attributable to a curvature in the curved section of the track, and to use the portion of fuel consumed attributable to the curvature in the track to determine the at least one rail wear characteristic for the curved section of the track.

Various components and modules described herein may be implemented as part of one or more computers, computing systems, or processors. The computer, computing system, or processor may include a microprocessor. The microprocessor may be connected to a communication bus. The computer or processor may also include a memory. The memory may include Random Access Memory (RAM) and Read Only Memory (ROM). The computer or processor further may include a storage system or device, which may be a hard disk drive or a removable storage drive such as a floppy or other removable disk drive, optical disk drive, and the like. The storage system may also be other similar means for loading computer programs or other instructions into the computer or processor. The instructions may be stored on a tangible and/or non-transitory computer readable storage medium coupled to one or more servers.

As used herein, the term “computer” or “computing system” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer” or “computing system.”

The set of instructions may include various commands that instruct the computer or processor as a processing machine to perform specific operations such as the methods and processes described herein. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings without departing from its scope. While the dimensions and types of materials described herein are intended to define the parameters, they are by no means limiting and are exemplary embodiments. Many other embodiments will be apparent to one of ordinary skill in the art upon reviewing the above description. The scope should, therefore, be determined with reference to the appended claims, along with the full scope of equivalents to which such claims are entitled. In the appended claims, the terms “including,” “includes,” and “in which” are used as the plain-English equivalents of the respective terms “comprising,” “comprises,” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments, and also to enable any person skilled in the art to practice the embodiments, including making and using any devices or systems and performing any incorporated methods. The patentable scope is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described systems and methods, without departing from the spirit and scope of the embodiments described herein, it is intended that all of the subject matter of the above description or shown in the accompanying drawings shall be interpreted merely as examples illustrating the inventive subject matter herein and shall not be construed as limiting.

1. A system comprising:
a simulation module configured to simulate performance of a first mission over at least one route by a first vehicle, the simulation module configured to simulate the performance of the first mission using route information corresponding to one or more characteristics of the at least one route and vehicle information corresponding to one or more characteristics of the first vehicle, the simulation module configured to determine performance characteristics for the first mission, the performance characteristics comprising at least one fuel usage characteristic evaluated for plural sections of the at least one route; and
a mapping module configured to provide a fuel efficiency map describing fuel usage along at least a portion of the at least one route using the performance characteristics determined by the simulation module.

2. The system of claim 1, wherein the at least one route comprises a track including one or more rails configured for passage thereon by a rail vehicle, further comprising a rail wear determination module configured to determine at least one rail wear characteristic using at least some of the performance characteristics determined by the simulation module.

3. The system of claim 2, wherein the rail wear determination module is configured to determine a portion of fuel consumed for a curved section of the track attributable to a curvature in the curved section of the track, and wherein the rail wear determination module is configured to determine the at least one rail wear characteristic for the curved section of the track using the portion of fuel consumed attributable to the curvature in the track.

4. The system of claim 1, wherein the simulation module is configured to perform at least a second simulation of at least a second mission, the mapping module is configured to provide at least a second fuel efficiency map based on the at least a second simulation, and further comprising an evaluation module configured to select, using the first and at least a second fuel efficiency maps, between at least one of:
a first route or a second route; or
a first vehicle configuration or a second vehicle configuration.

5. The system of claim 1, further comprising a control module configured to control at least one of the first vehicle or one or more other vehicles, while said at least one of the first vehicle or the one or more other vehicles actually travel over the at least one route, said control based at least in part on the fuel efficiency map.

6. A method comprising:
obtaining vehicle configuration information for a first vehicle;
obtaining route information for at least one route configured to be traversed by the first vehicle;
performing, using a simulation module, a first simulation of a first mission performed by the first vehicle;
determining, based on the first simulation, performance characteristics for the first mission, the performance characteristics comprising at least one fuel usage characteristic evaluated for plural sections of the at least one route; and
providing, using a mapping module, a fuel efficiency map describing fuel usage along at least a portion of the at least one route using the performance characteristics determined by the simulation module.

7. The method of claim 6, further comprising:
performing at least one second simulation of at least a second mission, the first simulation and the at least one second simulation differing from each other by at least one of varying vehicle configurations or varying routes;
determining performance characteristics for each of the first simulation and the at least one second simulation;
providing corresponding plural fuel efficiency maps for the first simulation and the at least one second simulation using the performance characteristics; and
evaluating the fuel efficiency maps, wherein the evaluating comprises comparing at least portions of the fuel efficiency maps for the simulations.

8. The method of claim 7, wherein the evaluating comprises selecting between alternate vehicle configurations based on the fuel efficiency maps.

9. The method of claim 7, wherein the evaluating includes selecting between alternate routes of the at least one route based on the fuel efficiency maps.

10. The method of claim 9, wherein the selecting between the alternate routes comprises selecting between prospective routes following different paths between a starting location and an ending location.

11. The method of claim 9, wherein the selecting between the alternate routes comprises selecting between prospective modifications to an existing route.

12. The method of claim 6, wherein the at least one route comprises a track comprising one or more rails configured for passage thereon by a rail vehicle, further comprising determining at least one rail wear characteristic using at least some of the performance characteristics.

13. The method of claim 12, wherein the determining the at least one rail wear characteristic comprises determining a portion of fuel consumed for a curved section of the track attributable to a curvature in the curved section of the track, and using the portion of fuel consumed attributable to the curvature in the track to determine the at least one rail wear characteristic for the curved section of the track.

14. The method of claim 6, further comprising controlling at least one of the first vehicle or one or more other vehicles, while said at least one of the first vehicle or the one or more other vehicles actually travel over the at least one route, said controlling based at least in part on the fuel efficiency map.

15. A tangible and non-transitory computer readable medium comprising one or more computer software modules configured to direct one or more processors to:
obtain vehicle configuration information for a first vehicle;
obtain route information for at least one route configured to be traversed by the first vehicle;
perform a first simulation of a first mission performed by the first vehicle;
determine, based on the first simulation, performance characteristics for the first mission, the performance characteristics comprising at least one fuel usage characteristic evaluated for plural sections of the at least one route; and
provide a fuel efficiency map describing fuel usage along at least a portion of the at least one route using the determined performance characteristics.

16. The tangible and non-transitory computer readable medium of claim 15 wherein the computer readable medium is further configured to direct the one or more processors to:
perform at least one second simulation of at least a second mission, the first simulation and the at least one second simulation differing from each other by at least one of varying vehicle configurations or varying routes;
determine performance characteristics for each of the first simulation and the at least one second simulation;
provide corresponding plural fuel efficiency maps for the first simulation and the at least one second simulation using the performance characteristics; and
evaluate the fuel efficiency maps by comparing at least portions of the fuel efficiency maps for the simulations.

17. The computer readable medium of claim 16, wherein the computer readable medium is further configured to direct the one or more processors to select between alternate vehicle configurations based on the fuel efficiency maps.

18. The computer readable medium of claim 16, wherein the computer readable medium is further configured to direct the one or more processors to select between alternate routes of the at least one route based on the fuel efficiency maps.

19. The computer readable medium of claim 18, wherein the computer readable medium is further configured to direct the one or more processors to select between prospective routes following different paths between a starting location and an ending location.

20. The computer readable medium of claim 18, wherein the computer readable medium is further configured to direct the one or more processors to select between prospective modifications to an existing route.

21. The computer readable medium of claim 15, wherein the at least one route comprises a track comprising one or more rails configured for passage thereon by a rail vehicle, and wherein the computer readable medium is further configured to direct the one or more processors to determine at least one rail wear characteristic using at least some of the performance characteristics.

22. The computer readable medium of claim 19, wherein the computer readable medium is further configured to direct the one or more processors to determine a portion of fuel consumed for a curved section of the track attributable to a curvature in the curved section of the track, and to use the portion of fuel consumed attributable to the curvature in the track to determine the at least one rail wear characteristic for the curved section of the track.
